(19) United States
(12) Patent Application Publication
(10) Pub. No.: US 2013/0177690 A1
(43) Pub. Date: Jul. 11, 2013

(54) Taste Modifying Composition

(71) Applicants: Yongquan Xue, Blaine, MN (US); Dan Wu, Beijing (CN); Lei Wang, Beijing (CN)

(72) Inventors: Yongquan Xue, Blaine, MN (US); Dan Wu, Beijing (CN); Lei Wang, Beijing (CN)

(73) Assignee: Yongquan XUE, Blaine, MN (US)

(21) Appl. No.: 13/277,768

(22) Filed: Oct. 20, 2011

Related U.S. Application Data
(60) Provisional application No. 61/405,088, filed on Oct. 20, 2010.
(60) Provisional application No. 61/408,809, filed on Nov. 1, 2010.

(51) Int. Cl. A23L 1/236

(52) U.S. Cl. CPC A23L 1/2361
USPC 426/548

(57) ABSTRACT

A taste modifying composition comprising L-theanine and stevia. Flavor and taste enhancement may also be made with L-theanine alone.

### CROSS-REFERENCE TO RELATED APPLICATIONS

This application is a conversion from U.S. Provisional Applications Nos. 61/405,088 filed Oct. 20, 2010 and 61/408,809 filed Nov. 1, 2010, the disclosures of which are both incorporated herein by reference.

### STATEMENT REGARDING FEDERALLY SPONSORED RESEARCH OR DEVELOPMENT

Not Applicable.

### BACKGROUND OF THE INVENTION

This invention relates to a new taste modifying composition that may be added as a sweetener or generally to improve the taste of food and beverages.

Stevia is a sweetener derived from the genus stevia of herbs and shrubs. Its sweetener extract has a slower onset and longer duration than sugar. It has been said to have up to 300 times the sweetness of sugar, which would be desirable in formulating low calorie, low sugar, low carbohydrate food and beverage alternatives. However, stevia extracts also have a bitter or licorice-like aftertaste, which has limited its appeal as a sweetener.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

The invention provides a sweetener and taste modifier for beverages and food containing stevia extract and L-theanine. L-theanine is Gamma-ethylamino-L-glutamic acid and is originally derived from green tea including Camellia sinensis, Camellia japonica, and Camellia sasanqua. L-Theanine provides a relaxing effect and a savory taste to green tea infusions.

The food systems tested with the composition of the invention include water, soda, tea, coffee, juice, yogurt, milk, cocoa and solid foods. It has been found that addition of L-theanine masks the bitter aftertaste of stevia extract and therefore makes a sweetener and smoother feel. It also allows greater use of stevia to increase the sweetness without the feeling of an artificial taste.

### DETAILED DESCRIPTION OF THE INVENTION

The invention is a composition including L-theanine and stevia extract which functions as a taste modifier for foods and beverages. Presence of L-theanine in the Stevia-Theanine combination reduces the after taste and artificial taste of Stevia extract. It also allows a greater amount of stevia extract to be present for its sweetening effect by helping to mask the aftertaste.

L-Theanine is an amino acid originally extracted from green tea. It is effective in lowering blood pressure, improving sleep, enhancing immune response, anti-fatigue, soothing emotions, focusing attention and losing weight. It is also helpful alleviating depression with no toxic side effect. It is known that L-theanine is one of the components in green tea that contribute to its umami flavor. Here we demonstrated, for the first time, that L-theanine can be used as a taste modifier, reducing the unpleasant aftertaste of stevia extract. Taste modifying compositions including L-theanine and stevia provides a smoother and richer taste to the food systems.

Taurine may be added to L-theanine in this additive to provide a unique fresh taste for yogurt. Taurine is a derivative of the amino acid cysteine. Beyond the taste modifying properties, yogurt with this additive tastes sweeter, smoother, and especially with a richer aftertaste. For children, the additive helps to protect their visual acuity and promote their physical growth and development.

D-ribose may be added to the formula and is helpful for the heart and muscles and enhances immunity. D-ribose is closely related with production and regeneration of adenosine triphosphate (ATP), which is the universal currency for energy in metabolism. It is especially critical for heart and muscles, where D-Ribose can promote recovery from ischemia and hypoxia. Beyond modifying the taste the additive also provide function to the food and beverages.

Fructo-oligose is a natural oligosaccharide, 0.3-0.6 times as sweet as table sugar. It has the pure sweet taste of sugar and tastes even fresher than pure sugar. Fructo-oligose is a probiotic. It helps to regulate enterobacteria, especially Bacillus bifidus and Lactobacillus, to promote calcium absorption, to regulate blood fat and immune system and to resist saprodontia. As fructo-oligose can't be digested and absorbed directly, it generates zero calories, so it is good for treating obesity and diabetic patients. Fructo-oligose also protects intestinal mucosa cells and liver and enhances immunity. Fructo-oligose may be added to the taste modifying compositions of this invention and provide a probiotic functionality.

### New Sweetener Compositions

TABLE 1.1
Stevia & L-Theanine

| Components | Stevia | Erythritol | Maltodextrin | L-Theanine |
|---|---|---|---|---|
| Percentage | 2.5-25% | 30-50% | 0-35% | 1-20% |

TABLE 1.2
Stevia & L-Theanine formulated with xylitol

| | | | | | L- |
|---|---|---|---|---|---|
| Components | Stevia | Erythritol | Xylitol | Maltodextrin | Theanine |
| Percentage | 2.5-25% | 30-50% | 5-20% | 0-25% | 1-20% |

TABLE 1.3
Stevia & L-Theanine formulated with glucose

| | | | | | L- |
|---|---|---|---|---|---|
| Components | Stevia | Erythritol | Glucose | Maltodextrin | Theanine |
| Percentage | 2.5-25% | 30-50% | 5-25% | 0-35% | 1-20% |

TABLE 1.4
Stevia & L-Theanine formulated with natural sugar

| Components | Stevia | Sugar | Maltodextrin | L-Theanine |
|---|---|---|---|---|
| Percentage | 2.5-25% | 30-50% | 0-35% | 1-20% |

TABLE 1.5
Stevia & L-Theanine formulated with polysaccharide

| Components | Stevia | Polysaccharide | Maltodextrin | L-Theanine |
|---|---|---|---|---|
| Percentage | 2.5-25% | 1--90% | 0-35% | 1-20% |

TABLE 1.6
Stevia & L-Theanine formulated with D-ribose

| Components | Stevia | D-ribose | Glucose | Sucralose | L-Theanine |
|---|---|---|---|---|---|
| Percentage | 1-20% | 5-50% | 0-40% | 0-20 | 1-20% |

TABLE 1.7
Stevia & L-Theanine formulated with amino acid

| Components | Stevia | Taurine | Fructo-oligose | L-Theanine |
|---|---|---|---|---|
| Percentage | 0.1-10% | 0.5-10% | 1-95% | 0.1-10% |

Description:

Each composition can be used as a food flavor in food or beverages. It can also be packaged into small packet or 1-2 grams in weight. One packet is adjusted to the sweetness of two teaspoonful of sugar. All components in the formula are natural food additives. The presence of L-theanine in these formulas brings much smoother and richer mouth feel to food systems tested including water, coffee or tea as demonstrated in taste panel tests.

TABLE 2.1
Sucralose and D-ribose Sweetener

| Components | Sucralose | Glucose | Maltodetrin | D-ribose |
|---|---|---|---|---|
| Percentage | 1-5% | 30-85% | 5-30% | 5-50% |

TABLE 2.2
Sucralose and D-ribose formulated with xylitol

| Components | Sucralose | Xylitol | Glucose | Maltodextrin | D-ribose |
|---|---|---|---|---|---|
| Percentage | 1-5% | 5-50% | 20-75% | 5-30% | 5-50% |

Description:

All components in it are natural food additives. As a new sweetener ingredient, D-ribose not only adds sweet taste to food and beverages, it also supplies energy.

### New Additive for Yogurt: Formulae and Functionality

TABLE 3.1
D-ribose Containing Additive for Yogurt

| Components | D-ribose | Fructo-oligose | Trehalose |
|---|---|---|---|
| Percentage | 1-90% | 5-80% | 5-50% |

Dosage: 1-5% (1-5 g in 100 g yogurt)

TABLE 3.2
L-Theanine containing Yogurt additive: Formula and Functionality

| Components | L-Theanine | Taurine | Fructo-oligose |
|---|---|---|---|
| Percentage | 0.1-10% | 0.5-10% | 1-95% |

Dosage: 1-5% (1-5 g in 100 g yogurt)

These formulas were tested especially well suited for yogurt. Formula in Table 3.1 provide energy as well as probiotic function to yogurt. Formula in Table 3.2 provide a unique meet taste.

### Taste Modification of L-Theanine on Stevia Extracts

It has been found that the taste improvement by adding L-theanine to stevia extract is dose dependent on the L-theanine. The more L-theanine more natural the taste. The taste improvement effect of L-theanine on stevia extract levels off when the ratio between L-theanine and stevia is larger than 5:1. However, taste improvement of L-theanine on foods and beverages were still significant even without stevia extract. L-theanine alone enhanced the taste and flavor of every food that we tested.

TABLE 4.1
Quantitative Descriptive Evaluation of Stevia Taste Modifier
N = 16 (8 Panelists, 2 Evaluation Each)

| Stevia:Theanine = | Stevia:Theanine = | Stevia:Theanine = | Stevia:Theanine = | Stevia:Theanine = |
|---|---|---|---|---|
| 1:0 | 1:0.5 | 1:1 | 1:3 | 1:5 |

Flavor

| | | | | | |
|---|---|---|---|---|---|
| Total Flavor | 7.19 | 7.48 | 7.34 | 7.39 | 7.52 |
| Sweetness | 6.73 | 6.87 | 6.68 | 6.91 | 7.00 |
| Artificial/Chemical Taste | 2.85 | 2.51 | 2.28 | 2.18 | 2.01 |
| True Bitterness | 1.61 | 1.31 | 1.37 | 1.15 | 1.09 |
| Dry/Powdery feel | 2.28 | 2.05 | 2.24 | 2.52 | 2.14 |

After Taste

| | | | | | |
|---|---|---|---|---|---|
| Total After Taste | 4.46 | 4.57 | 4.88 | 4.89 | 4.93 |
| Sweetness | 4.03 | 4.01 | 4.08 | 4.23 | 4.26 |
| Artificial/Chemical taste | 2.76 | 2.57 | 2.46 | 2.40 | 2.11 |
| True Bitterness | 1.43 | 1.38 | 1.33 | 1.25 | 1.23 |

The best ratio between L-theanine and stevia extract is 1:1 to 3:1. Within this ratio range, the composition significantly enhances the freshness of yogurt and milk. It makes milk, yogurt, and juice taste richer. It makes green tea taste fresher and clearer, and red tea taste richer. It also improves the taste of coffee, reducing bitterness and revealing a fuller taste and aroma. In every case, the L-theanine-stevia composition makes foods taste richer than without L-theanine addition. Again, we also noticed that L-theanine alone enhanced the taste and flavor of every food and beverage that we tested. Testing demonstrated that an L-theanine-stevia composition is the favorite among all the stevia packets tested.

### Taste Evaluation and Comparison of Stevia-Theanine Formulas

Stevia extracts of different specifications (of different Rebaudioside A (RA) content and Steviol Glycosides (SG) contents) were formulated with maltodextrin, glucose, erythritol, and L-theanine at various concentrations. Eight samples were such prepared into 1 gram per bag or 2 grams per bag configurations. The content of each sample/bag is dissolved into 150 ml of pure water in a cup. Eleven individuals (Four males and Seven females age from 20 to 50) who have no knowledge of the formulas were asked to evaluate the sample out of each cup that is double blindly coded. The taste parameters are Sweetness (SWT) and Bitterness after tastes that are associated with stevia samples.

The Double Coding of the Testing Samples:

Each formula was marked on the bottom of its cup and the cups were randomly placed. Then each cup was labeled according to its location (with is random) in a row. The test result of each tasting individual to a specific sample was recorded and later decoded as following.

The corresponding sample number, formula mark, and its formula is

### A-8; B-1; C-4; D-5; E-2; F-7; G-6; H-3.

The formulas are
1). 1 g/bag, Stevia extract (RA60, SG 95%), Maltodextrin, Glucose, L-Theanine.
2). 1 g/bag, Stevia extract (RA60, SG 95%), Maltodextrin, Erythritol, L-Theanine.
3). 2 g/bag, Stevia extract (RA60, SG 95%), Erythritol, L-Theanine.
4). 2 g/bag, Stevia (RA60, SG 95%), Erythritol, Maltodextrin, L-Theanine.
5). 2 g/bag, Stevia extract (RA60, SG 95%), Erythritol, Maltodextrin, Glucose, L-Theanine.
6). 2 g/bag, Stevia extract (RA60, SG 90%), Eryhtritol, L-Theanine.
7). 2 g/bag, Stevia extract (RA60, SG 90%), Erythritol, Maltodextrin, L-Theanine.
8). 2 g/bag, Stevia extract (RA60, SG 90%), Eryhtritol, Maltodextrin, Glucose, L-Theanine.

Each tasting individual was also asked to vote his/her favorite sample/formula. After decoding the sample number, the most favorite formula are: A with 4 favorite votes, D with 3 favorite votes, B, C, or F with 1 favorite vote, and E or H with zero favorite vote.

Results:

The testing result is tabulated in table 5.1. Comparing with previous results, addition of L-theanine greatly reduces the bitterness after taste of stevia extracts. The bitterness after taste is not strong in each sample of this group tested. Of the three samples (Samples A-8, H-3, and B-1) that have the highest and most significant Sweetness over Bitterness ratio (SWT/BT) the only common factor is L-theanine. Therefore, L-theanine is the ingredient that reduces the after taste of stevia extracts. Other ingredients, such as erythritol, maltodextrin, and glucose, also help to improve the taste of stevia extracts. However, their contribution is in other aspects and incremental. The individuals in the tasting group favor the formula that has more ingredients, which tend to have a richer and smoother taste than samples that have fewer ingredients.

TABLE 5.1
Taste Evaluation of Stevia Formulas

Sample

| and its | Sample A | | Sample B | | Sample C | | Sample D | |
|---|---|---|---|---|---|---|---|---|
| Tastes | SWT | BT | SWT | BT | SWT | BT | SWT | BT |
| F-33 | +++ | ++ | ++ | + | ++ | + | + | + |
| F-40 | ++++ | + | ++++ | + | ++++ | + | ++++ | ++ |
| F-28 | ++++ | ++ | ++++ | + | +++ | + | ++++ | ++ |
| F-27 | +++ | + | +++ | + | ++ | + | +++ | + |
| M-32 | +++ | + | +++ | ++ | +++ | ++ | +++ | ++ |
| M-45 | ++++ | + | +++ | ++ | ++ | ++ | ++ | ++ |
| F-28 | +++ | + | ++ | + | ++++ | ++ | ++ | ++ |
| F-26 | ++++ | ++ | ++++ | + | ++++ | + | +++ | + |
| F-46 | +++ | + | ++ | + | +++ | + | +++ | + |
| F-45 | ++++ | + | +++ | + | +++ | + | ++ | + |
| M-47 | ++++ | ++ | +++ | ++ | +++ | ++ | +++ | + |
| Total | 3.55+ | 1.36+ | 3.0+ | 1.27+ | 2.82+ | 1.37+ | 2.73+ | 1.45+ |
| Average | | | | | | | | |

| | | | | |
|---|---|---|---|---|
| SWT/BT | 2.61 | 2.36 | 2.06 | 1.88 |

Sample

| and its | Sample E | | Sample F | | Sample G | | Sample H | | Favorite |
|---|---|---|---|---|---|---|---|---|---|
| Tastes | SWT | BT | SWT | BT | SWT | BT | SWT | BT | Sample |
| F-33 | + | + | ++ | + | ++ | + | ++ | + | A |
| F-40 | ++ | + | ++++ | + | ++++ | + | +++ | + | C |
| F-28 | +++ | + | ++ | + | ++++ | ++ | +++ | + | B |
| M-27 | ++ | + | ++ | ++ | ++ | ++ | +++ | ++ | A |
| M-32 | ++ | + | ++ | ++ | ++ | +++ | +++ | ++ | A |
| M-45 | +++ | ++ | +++ | ++ | ++ | +++ | +++ | ++ | B |
| F-28 | ++ | + | ++ | + | ++ | ++ | ++++ | + | A |
| F-26 | ++ | + | ++++ | ++ | ++++ | + | ++++ | + | D |
| F-46 | +++ | + | +++ | + | +++ | + | +++ | ++ | D |
| F-45 | ++ | + | ++++ | + | ++++ | + | ++++ | ++ | F |
| M-47 | +++ | ++ | ++++ | + | +++ | + | +++ | + | D |
| Total | 2.28+ | 1.19+ | 2.91+ | 1.37+ | 2.91+ | 1.64+ | 3.19 | 1.33+ | |
| Average | | | | | | | | | |

| | | | | |
|---|---|---|---|---|
| SWT/BT | 1.92 | 2.12 | 1.77 | 2.40 |

SWT (sweetness): +Not Sweet; ++Slightly Sweet; +++Sweet; ++++Very Sweet; BT (Bitterness after taste): +Not Bitter; ++Slightly Bitter; +++Bitter; ++++Very Bitter

### Flavor Enhancement of L-Theanine for Food and Beverages

L-Theanine alone improves the taste and flavor of food and beverages. It makes the food and drink taste richer, smoother, and sweeter. For tea and tea-based beverages, such ash red tea and green tea, a very small amount of L-theanine significantly improves its taste and flavor. However, a larger amount of L-theanine is necessary for milk and milk based beverages and foods. This dosage is different from the Stevia-Theanine combination that we have tested previously.
1). For tea and tea-based beverages, the optimal dosage of L-theanine is 0.025% -0.1%. Higher dosage does not shown much more effects. A small dosage is enough to have a significant improvement.
2). For juices and juice-based beverages, the optimal dosage of L-theanine is 0.025-0.2%. Larger amounts also improves the flavor and taste, but its effect levers Off. Addition of L-theanine makes juice and juice-based beverages taste smoother and richer.
3). For milk and milk-derived products such as yogurt and ice cream, the optimal dosage for L-theanine is 0.05% -0.2%. Addition of 1-theanine enhances the milk taste and aroma of the product.
4). For coffee and coffee-like products, the optimal dose for L-theanine is 0.05% -0.2%, similar to the dosage in milk product. Addition of L-theanine makes coffee taste richer and fuller.
5). For cocoa and cocoa-like products, the optimal dosage of L-theanine is 0.05% -0.2%. Higher dosages improves, but less dramatically, the taste and flavor. L-theanine enhances the aroma of cocoa.

While this invention may be embodied in many different forms, there are shown in the drawings and described in detail herein specific preferred embodiments of the invention. The present disclosure is an exemplification of the principles of the invention and is not intended to limit the invention to the particular embodiments illustrated.

This completes the description of the preferred and alternate embodiments of the invention. Those skilled in the art may recognize other equivalents to the specific embodiment described herein which equivalents are intended to be encompassed by the claims attached hereto.

1. A taste modifying composition comprising:
(a) stevia extract; and
(b) L-theanine.

2. The taste modifying composition of claim 1 wherein said L-theanine to stevia extract ratio is between about 0.5:1 and 5:1.

3. The taste modifying composition of claim 1 wherein said L-theanine to stevia extract ratio is between about 1:1 and 3:1.

4. The taste modifying composition of claim 1 further including a compound selected from the group consisting of sugar, sugar alcohol, D-ribose, Taurine, polysaccharides, and flavors.

5. A sweetener comprising:
(a) stevia extract; and
(b) L-theanine wherein said L-theanine to stevia extract ratio is between about 05:1 and 5:1.

6. A method for improving the taste of a food or beverage comprising the steps of:
(a) adding stevia extract to said food or beverage; and
(b) adding L-theanine to said food or beverage, with the ratio of L-theanine to stevia extract being between about 0.5:1 and 5:1.

7. A method for improving the taste of a food or beverage by adding the sweetener of claim 5.

8. A method for enhancing the flavor and taste of beverages or food comprising the step of:
(a) adding between about 0.025 to about 0.2% L-theanine to said beverage or food.

9. The method of claim 8 wherein the beverage is a tea or tea-based beverage, and the L-theanine is added at between about 0.025-0.1%.

10. The method of claim 8 wherein the beverage is a juice or juice-based beverage, and the L-theanine is added at between about 0.025-0.2%.

11. The method of claim 8 wherein the beverage is a milk or milk-based beverage, and the L-theanine is added at between about 0.05-0.2%.

12. The method of claim 8 wherein the beverage is a coffee or coffee-based beverage, and the L-theanine is added at between about 0.05-0.2%.

13. The method of claim 8 wherein the beverage is a cocoa or cocoa-based beverage, and the L-theanine is added at between about 0.05-0.2%.
